(19) United States
(12) Patent Application Publication
(10) Pub. No.: US 2012/0048037 A1
(43) Pub. Date: Mar. 1, 2012

(54) CARTRIDGE AND OPERATING METHOD FOR REAGENTS OF A BIOSENSOR SYSTEM

(76) Inventors: Heike Barlag, Nurnberg (DE); Jochen Ostermaier, Erlangen (DE)

(21) Appl. No.: 13/138,952

(22) PCT Filed: Mar. 9, 2010
(86) PCT No.: PCT/EP2010/052969

§ 371 Date: Oct. 31, 2011

(30) Foreign Application Priority Data
Apr. 30, 2009 (DE) 10 2009 019 650.1

(51) Int. Cl. G01N 1/22

(52) U.S. Cl. 73/863.21

(57) ABSTRACT

A cartridge provides reagents for a biosensor system. The cartridge has at least two containers, the upper sides of which are each sealed by a foil in an airtight and waterproof manner. The at least two containers have sloped bases, the slopes of which are aligned identically. The cartridge can be coupled to a biosensor system in that a hollow needle which is fixed at the sensor system extends through the foil of the at least one of the at least two containers in a coupled state. The end of the hollow needle is positioned in the vicinity of the base of the corresponding container. A drying agent for the water-free storage or for the ventilation of reagents is provided in the cartridge.

### CROSS REFERENCE TO RELATED APPLICATIONS

This application is based on and hereby claims priority to International Application No. PCT/EP2010/052969 filed on Mar. 9, 2010 and German Application No. 10 2009 019 650.1 filed on Apr. 30, 2009, the contents of which are hereby incorporated by reference.

### BACKGROUND

The invention relates to a cartridge used with fluids.

The use of biosensors which, as a rule, can detect organic substances is generally known. The central biosensor usually holds a specific enzyme. What is usually measured is catalytic activity, said measurements being evaluated comparing a measurement with a sample and a measurement without a sample. Since enzymes, that is, proteins are used in a biosensor, the use of such biosensor systems is associated therewith that certain operating materials have a limited storage life. Supplying a biosensor system therefore requires a series of reagents. Said reagents are used up during operation of the biosensor system and must be replenished from time to time.

If a “low-maintenance” device is desired, such replenishment should be necessary no more frequently, for example, than once per week. This means that reagents contained in the cartridge must be handled in such a way as to be stable for at least one week.

The reagents that are needed for a biosensor in a biosensor system usually exist in a liquid form, so that coupling to a biosensor system usually takes place via the liquid phase. Conventionally, reagents are individually mixed and transferred to suitable containers.

### SUMMARY

It is one possible object to provide a cartridge by which all the liquids for operating a biosensor system can be stored in sealed manner, the volume of the respective reagents held in a container of the cartridge being optimized by adaptation of the container size so that the reagents are used up without residue. It is a further potential object to provide an operating method for using a cartridge of this type, wherein water-free reagents are to be protected.

The inventors propose a cartridge and method with which the volumes of reagents and of the corresponding containers is optimized according to the specific use thereof. At the same time, a cartridge with a plurality of containers already has all the liquids and reagents for operation of a biosensor system, stored in sealed manner, and has the advantage that when the cartridge is stored, said reagents can be kept in an aqueous or a water-free state. The different volumes of the containers in a cartridge means that the reagents associated with different specific consumption levels during operation of the biosensor can be provided in such a way that complete emptying of the individual containers within a predefined time, for example a week, is possible. Accordingly, the volumes of the individual containers of the cartridge are adapted to the specific consumption of the reagents.

The containers have a base that is inclined to the horizontal, the coupling to the biosensor system being achieved with hollow needles which, in the coupled state, are pushed through the foil and have their ends positioned in the lowest region of the inclined base.

The introduction of an additional depression in the deepest region of the downwardly inclined base of each container, for example, in the form of a hemispherical depression advantageously enables the utilization of the individual reagents during operation of the biosensor down to a small residual amount.

Advantageously, ventilation of the individual containers is provided for pressure equalization in that, in addition to an opening for hollow needles for removing reagents, an opening is made in the foil of the same container, serving the ventilate the container.

The ventilation can be achieved, in particular, with a water-free gas, so that reagents that are susceptible to hydrolysis are supplied, for example, with dry air. Any gas not containing water can also be used.

The design of the closed volumes realized by the containers of a cartridge provides for the delimitation at the top and the sealing of the containers by a foil. Biological reagents and substances which are generally susceptible to hydrolysis are therefore stored water-free in the containers.

It is highly advantageous for a drying agent to be provided directly at the cartridge in order to prepare water-free gas.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIGS. 1, 1A, 1B show a plan view and sectional side views of a cartridge 10 showing the outlines of the individual containers 11-17,

FIGS. 2, 2A, 3, 3A, 4, 4A each show a plan view of the cartridge and a sectional view as per section A-A, during ventilation with dry gas,

FIGS. 5, 5A, 6, 6A each show a plan view of the cartridge and a sectional view as per section A-A, for long-term storage of reagents.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

A cartridge 10 having a plurality of containers 11-17 contains all the liquids, particularly reagents, for the operation of a biosensor in a biosensor system. The advantage of the inventors proposals lies therein that the volume ratios of the individual containers are matched to consumption during operation of the biosensor and thus make possible complete emptying of all the containers simultaneously at a predetermined time.

The hollow needles 5 are rigidly linked to the biosensor system. This prevents hoses at the rear side of the hollow needles 5 being moved, leading to faults occurring, for example, due to kinking of the hoses. Kinking of the hoses fatigues the material thereof and the inner volume thereof becomes altered, so that following connection of the cartridge, air can appear in the hoses.

Water-free ventilation of individual containers enables the storage of reagents that are susceptible to hydrolysis in water-free organic solvents.

The storage of individual reagents in the cartridge can therefore be carried out without cooling.

In order to ventilate with water-free air, for example, a water absorber can be connected upstream so that containers are filled with ambient air that is dried by prior treatment.

In order to achieve emptying of all containers simultaneously with the least possible residue, the ends of the hollow needles 5 are positioned on the side of a container close to a depression 18 which is arranged in a base 21 of each container. The base of each individual container is arranged inclined.

The reagents that are to be stored and made available for operation of the biosensor are placed in a cartridge. The number of containers corresponds, as a rule, to the number of reagents. The container size is chosen so that, after a defined measuring time, such as a week, as little residue as possible is found in any of the containers in the cartridge. The volume ratios are represented schematically by the different sized outlines of the individual containers. Account is taken of the specific usage of the reagents from the individual containers.

A biosensor system can be equipped. Here, the individual chambers can be penetrated through a foil 22, creating a fluid coupling to the biosensor system.

In order not to generate a negative pressure within a container by operation of the biosensor system and the removal of reagents from the containers, resulting in the blocking of fluid removal, openings or holes are punched in the foil so as to ventilate containers when the cartridge is coupled in.

Specifically for ventilating individual containers containing reagents that need to be stored water-free, a ventilation system is provided in combination, for example, with an element for the supply of dry gas, such as dry air. Alternatively, water-free gases can also be used for rinsing relevant containers.

Reagents are preferably present in the form of fluids and can be provided, for example, as chemical buffers in three different compositions such as hydrochloric acid, a mixture of different enzymes and two different water-soluble solutions of enzyme substrates. The water-free solutions of enzyme substrates are mixed with buffer solutions ready for use relatively soon before use in the biosensor system, since said solutions are susceptible to hydrolysis. The water-free stock solutions must therefore also not come into contact with moist air. In order to receive the respective reagents, the relevant containers must therefore be ventilated with dry air or other dry gases.

Chemical buffers and the enzymes can be stored dry in the cartridge. In this way, said substances have particularly good storage properties so that cooling during storage can be dispensed with. Following coupling of the cartridge to a biosensor system, the individual containers holding dry-stored reagents are filled with ultrapure water. In this way, said reagents are made ready for use and the cartridge is usable with all the reagents.

Where a biosensor or the cartridge is used at particularly warm deployment sites, the cartridge can be cooled. For this purpose, the use of a metal plate beneath the cartridge in combination with a Peltier element which cools said metal plate is possible. The metal plate can be specifically formed so that the thermally sensitive reagents are cooled particularly well.

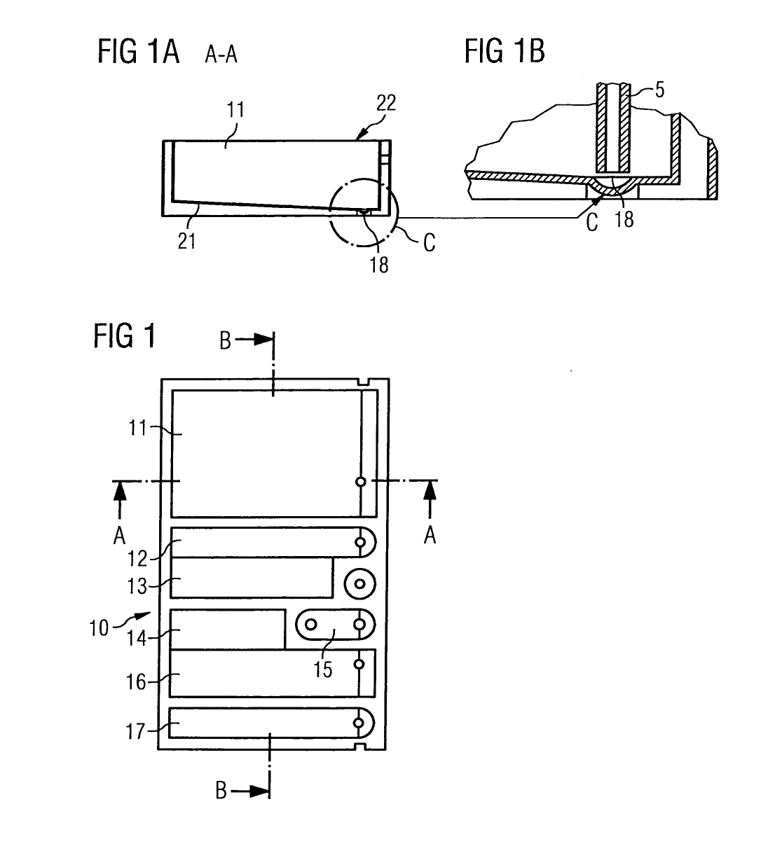

It should be noted in regard to FIGS. 1, 1A and 1B that these show a cartridge from various viewing directions, partially in section, and details thereof. FIG. 1 shows a cartridge 10 in plan view, containers 11-17 of different sizes being shown in outline. Furthermore, circles indicate the points at which hollow needles 5 are pushed through a foil covering the containers, at the top thereof. Located at said circles visible in FIG. 1 are the depressions 18 of the base of the cartridge, the hollow needles 5 introduced with the ends thereof from above into the containers 11-17 being positioned, in the state of the cartridge coupled to a biosensor system, close to the depression 18.

FIG. 1A shows the section A-A of FIG. 1, the inclined base of the container 11 having the depression 18. The figure shows an approximately hemispherical formation. The same subject matter is shown again as detail C in FIG. 1B.

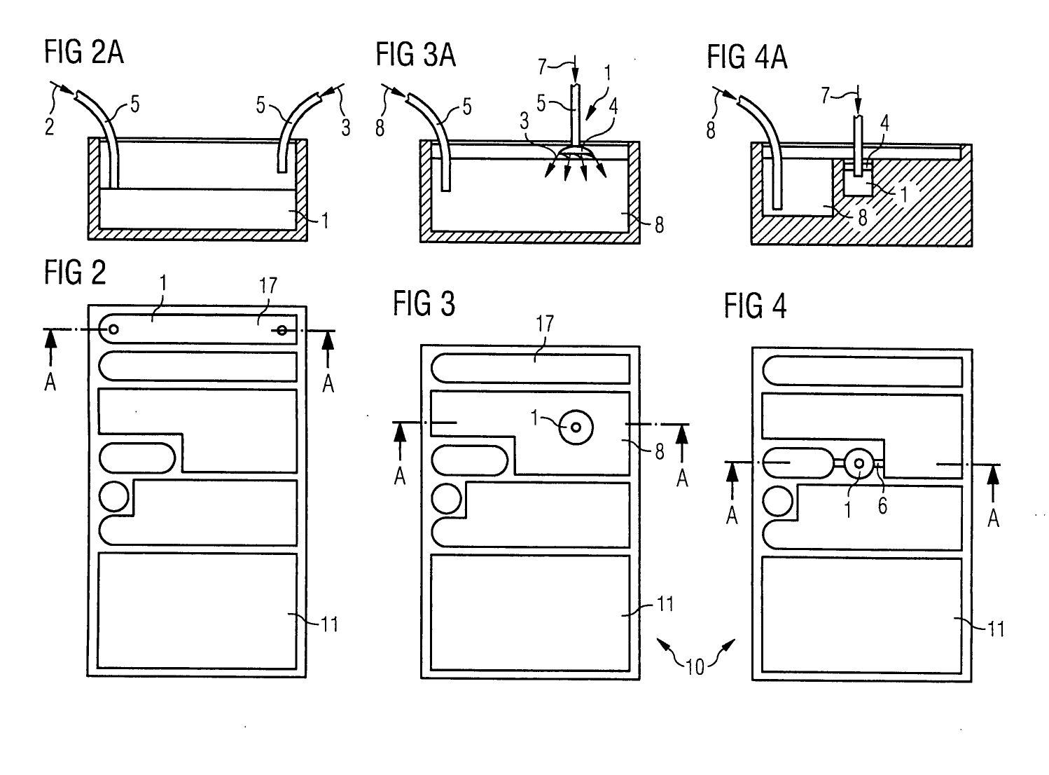

FIGS. 2 and 2A show a variant with drying agent 1 on the cartridge in the container 17. A dried, and therefore water-free, gas can be generated and introduced for ventilating containers on removal of reagents therefrom.

FIGS. 3 and 4 with the associated FIGS. 3A and 4A show, in a plan view and the associated sectional view, other ventilation possibilities, the dried air 3 being generated from outside air 7 in a plurality of variants and fed to the specific containers. In FIG. 3A, the ventilation air 7 is fed to and passed through the drying agent 1 so that dried air 3 is produced.

In FIG. 4A, a membrane 4 which prevents mixing of reagents and drying agents, but permits drying of gas, is used.

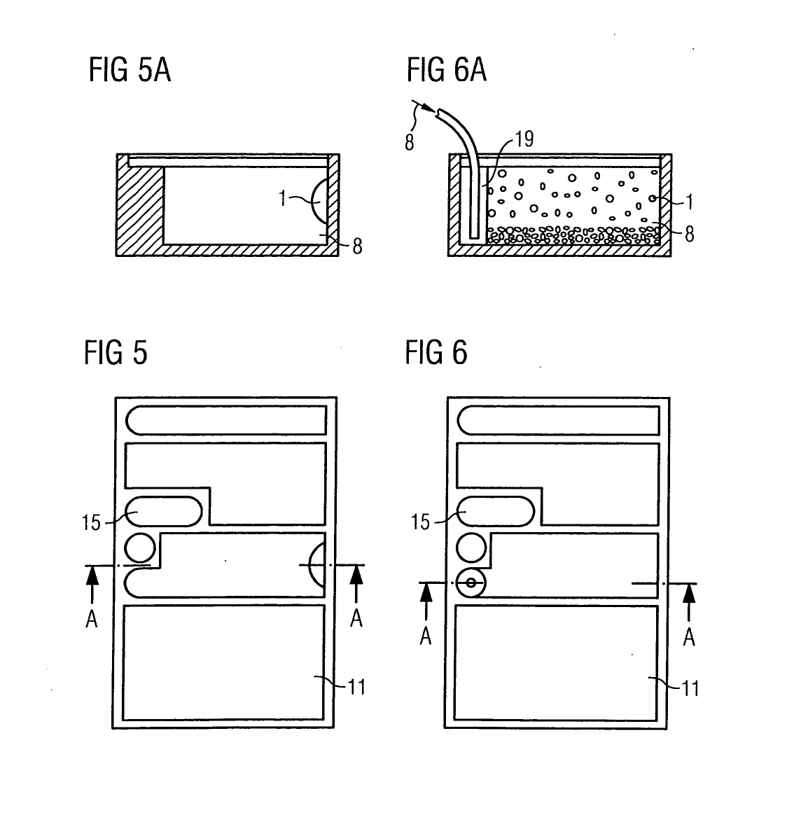

FIGS. 5, 5A and 6, 6A show storage variants for the drying agent 1. In FIG. 5A, a store is created in which, for example, direct drying of a reagent 8 takes place via a semi-permeable membrane. In FIG. 6A, the reagent 8 and the drying agent 1 are mixed and are only separated on removal of the reagent 8.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV,

1-15. (canceled)

16. A method for operating a cartridge which comprises at least two containers to provide reagents for a biosensor system, comprising:
providing a first reagent in aqueous solution in a first container of the cartridge;
providing a second reagent in a water-free solvent in a second container of the cartridge, separate from the first container;
sealing the reagents in the containers in a water-tight and air-tight manner using a protective film;
coupling the biosensor system to the cartridge to pierce the film with at least one hollow needle associated with the biosensor system;
removing the first and second reagents from the first and second containers, respectively; and
equalizing pressure in the first and second containers upon respective removal of the first and second reagents, the pressure in the second container being equalized with a water-free gas.

17. The method as claimed in claim 16, wherein
the water-free gas is dried air, and
dried air is generated by a drying agent stored in the cartridge and fed to the second container for pressure equalization.

18. The method as claimed in claim 17, wherein the drying agent is mixed with the second reagent for water-free storage of the second reagent.

19. The method as claimed in claim 16, wherein the drying agent is separated from the second reagent with a semi-permeable membrane.

20. The method according to claim 16, further comprising cooling the reagent in at least one of the containers.

21. The method according to claim 16, wherein
the cartridge contains at least first, second and third containers,
the first container contains a non-cooled aqueous solution selected from the group consisting of a buffer solution, an acid and an alkali,
the third container contains a cooled aqueous enzyme solution,
the second container contains the second reagent in the water-free solvent, and
the water-free solvent is selected from the group consisting of ethylene glycol, acetonitrile, dimethyl sulfoxide, dioxane, and N-methylpyrrolidone.

22. The method as claimed in claim 16, wherein
the first and second containers have volumes configured such that, during operation of the cartridge, the reagents held in the at the first and second containers are used up simultaneously in the biosensor system.

23. The method as claimed in claim 16, wherein
the cartridge contains at least first, second and third containers,
the first container has a first volume and contains a non-cooled aqueous solution selected from the group consisting of a buffer solution, an acid and an alkali,
the third container has a third volume and contains a cooled aqueous enzyme solution,
the second container has a second volume and contains the second reagent in the water-free solvent,
the water-free solvent is selected from the group consisting of ethylene glycol, acetonitrile, dimethyl sulfoxide, dioxane, and N-methylpyrrolidone, and
a ratio of first volume:third volume:second volume is approximately 900:1:20.

24. The method as claimed in claim 16, further comprising monitoring water quality using the cartridge.

25. The method as claimed in claim 16, wherein the protective film is a foil.

26. A cartridge to provide reagents for a biosensor system, comprising:
first and second containers, each having an at least partially open upper side sealed in an air-tight and water-tight manner by a protective film, wherein
each container has an inclined base with respect to a bottom of the cartridge, the containers being aligned such that each inclined base has an identically aligned slope, and
the containers are located in the cartridge such that when the cartridge is coupled to the biosensor system, the first and second containers receive first and second hollow needles fixed to the biosensor system, each of the hollow needles piercing through the protective film such that in the coupled state, an end of the hollow needle is positioned in a vicinity of the base of a respective container.

27. The cartridge as claimed in claim 26, wherein each container has a depression set into the base to form a deepest site at the base of the container.

28. The cartridge as claimed in claim 26, further comprising a drying agent stored in the cartridge to generate a water-free gas.

29. The cartridge as claimed in claim 28, wherein
the second container contains a reagent in a water-free solvent, and
the second container is in ventilation communication with the drying agent.

30. The cartridge as claimed in claim 28, wherein the drying agent is separated from the containers by a membrane to prevent mixing with reagents.

31. The cartridge as claimed in claim 28, wherein
the second container contains a reagent in a water-free solvent,
the drying agent is mixed with the reagent in the water-free solvent, and
a reagent-permeable grid permits selective removal of the reagent without the drying agent.

32. The cartridge as claimed in claim 26, wherein
the cartridge contains at least first, second and third containers,
the first container contains a non-cooled aqueous solution selected from the group consisting of a buffer solution, an acid and an alkali,
the third container contains a cooled aqueous enzyme solution, and
the second container contains a reagent in a water-free solvent selected from the group consisting of ethylene glycol, acetonitrile, dimethyl sulfoxide, dioxane, and N-methylpyrrolidone.
